(19) United States
(12) Patent Application Publication
(10) Pub. No.: US 2010/0229546 A1
(43) Pub. Date: Sep. 16, 2010

(54) Heat Engine

(76) Inventor: Roland Nagler, Topen (DE)

Correspondence Address: Oppedahl Patent Law Firm LLC (P&A), P O Box 5940, Dillon, CO, 80435-5940, US

(21) Appl. No.: 12/757,715

(22) Filed: Apr. 9, 2010

Related U.S. Application Data
(63) Continuation-in-part of application No. PCT/EP2008/008445, filed on Oct. 10, 2008.

(30) Foreign Application Priority Data
Oct. 10, 2007 (DE) 102007048639.3

(51) Int. Cl. F02G 1/04

(52) U.S. Cl. 60/517

(57) ABSTRACT

A heat engine has four oscillating pistons which lie at a right angle to one another are located in four cylinders. The pistons and the cylinders are of wedge-shaped configuration and have the shape of a cone section. The pistons rest with their lower tip on a piston bearing. The four cylinders are connected to one another by means of channels; compression chamber to displacement chamber and displacement chamber to compression chamber. The crank rotates in this method of operation counter to the gas flow. The engine is applied in the stationary area, preferably in order to generate electricity and heat decentrally in the context of power/heat cogeneration with the use of renewable resources. It is to be possible, inter alia, to also use the heat engine for the low and medium temperature range and to make few demands of the quality of the fuels.

### CROSS REFERENCE APPLICATIONS

This application is a continuation in part of and claims the priority of international application no. PCT/EP2008/008445 filed on Oct. 10, 2008, which claims priority from German Patent application no. DE 10 2007 048 639.3 filed on Oct. 10, 2007, each of which is hereby incorporated by reference in its entirety.

### FIELD OF THE INVENTION

This invention concerns a heat engine for external combustion which generates heat and electricity using renewable raw materials.

### BACKGROUND

Most known heat engines utilize internal combustion inside a cylinder, as seen in otto and diesel engines, for example.

Internal combustion inside a cylinder excludes a variety of combustible materials, including existing natural resources. Steam engines and steam turbines can combust other materials, but steam engines and steam turbines require greater scale, and therefore are not suited for decentralized provision of energy.

Another known engine type is the Stirling engine, wherein the combustion takes place outside the cylinders. Stirling engines are generally suitable for a great number of different fuels.

German patent application DE 10 2006 001 299 A1 describes a Stirling engine, which utilizes renewable raw materials for combined heat and power generation.

EP 1455117 describes another Stirling engine which requires high quality fuels.

Known Stirling engines require very high temperatures at the heater head to achieve an economic use of heat, which limits the type of fuel used and gives rise to material related problems.

The Stirling principle includes a compression cylinder and a displacing cylinder. The cylinders are connected by a channel, which further comprises a regenerator, which is necessary for obtaining a high efficiency. During one gas exchange cycle, the working gas is heated up inside the compression sub-chamber, and then transferred to the displacing sub-chamber where it is cooled down before it is transferred back to the compression sub-chamber. Since both chambers are connected, they have the same pressure at all times.

Further patents applying the Stirling principle are U.S. Pat. No. 5,077,976; FR 2 846 375; U.S. Pat. No. 4,545,205 and U.S. Pat. No. 4,312,181.

U.S. Pat. No. 4,545,205 describes a heat engine wherein four cylinders are arranged about a central crankshaft. This engine displays a very limited heat transfer area due to its geometric configuration.

U.S. Pat. No. 5,077,976 and French Patent No. FR 2 846 374 also display a limited heat transfer area. Further, in U.S. Pat. No. 5,077,976 a hydraulic piston arrangement transmits force, which leads to substantial friction losses. U.S. Pat. No. 4,312,181 describes a Stirling engine, wherein the heat transfer is applied by a separate external heat exchanger, which leads to further heat losses.

Effective heat transfer in and out of working gas is problematic for a number of known Stirling engines. In order to reach a sufficient temperature gradient at the heater head, combustion temperatures have to be comparably high or heat transfer areas must have a high surface area, which is provided by rib structures or the like.

Regenerative fuels tend to show imperfect combustion properties in particular. Combustion temperatures for regenerative fuels are lower than the combustion temperature for gas. Regenerative fuels also tend to produce soot, making it impossible to rely on fine structured heat transfer structures or the like.

The foregoing example of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tool and methods which are meant to be exemplary and illustrative, not limiting in scope. In various embodiments, one or more of the above described problems have been reduced or eliminated, while other embodiments are directed to other improvements.

One aspect of the disclosed device is to provide a heat engine for the combustion of regenerative fuels.

The disclosed heat engine for external combustion from regenerative fuels comprises a heated compression sub-chamber, a cooled displacing sub-chamber and a piston operated between the chambers. The piston and crankshaft have a highly symmetrical arrangement, leading to an optimized thermodynamic cycle. Optimized geometric properties also allow for effective heat uptake.

Of course, any other kind of mechanical power buffer system could be used instead of a crankshaft.

The invention is applicable to stationary engines, preferably for creating electricity and heat in a decentralized manner and using renewable raw materials within the framework of combined heat and power generation.

Another aspect of the disclosed heat engine is to use the piston and cylinder to provide a large heat uptake area, while limiting the number of moveable parts.

The disclosed heat engine can be used at to the low and medium temperature region, and has few restrictions on the quality of the fuels.

In one embodiment, the heat engine comprises a crankshaft, a heat reservoir, a heat sink and four chambers. Each chamber comprises a compression sub-chamber and a displacing sub-chamber separated and sealed from one another by a piston. When piston movement increases the volume within a compression sub-chamber, the volume in the corresponding displacing sub-chamber decreases, and vice versa. All compression sub-chambers are in thermal connection with the heat reservoir, and all displacing sub-chambers are in thermal connection with the heat sink. The four chambers are arranged cyclically in order, either clockwise or counterclockwise. In this cyclical arrangement, a fluid duct connects each compression sub-chamber to the subsequent displacing sub-chamber and each displacing sub-chamber to the subsequent compression sub-chamber. Each piston is mechanically connected to a crankshaft by a mechanical means able to transmit force between said piston and said crankshaft.

The fluid ducts may be open or closed depending on the position of any of the pistons of any of the chambers they connect.

The compression sub-chambers and/or displacing sub-chambers may have the fluid ducts as their only openings. The volume of the compression sub-chambers and/or displacing sub-chambers may only change by the movement of a corresponding piston or by opening or closing said corresponding fluid ducts.

The four chambers may be arranged about a free internal space comprising said heat reservoir, which is in heat contact with the respective compression sub-chambers of the four chambers.

Four upper heat exchange chambers may be mounted above the free internal space. Each upper heat exchange chamber is separate from, but in thermal contact with, the free internal space. Each upper heat exchange chamber is in fluid contact with the respective compression sub-chamber.

Said four upper heat exchange chambers may be thermally isolated towards upwards. This arrangement is described in greater detail below.

Each of the compression sub-chambers may be in fluid contact with a corresponding additional heat transfer chamber provided at portions of the furnace room adjacent to it.

The free internal space may be constructed such that substantially all of its surfaces, except areas needed for possible passage of fuel supply, delivery of air or exhaust of fumes from burning are used for either transmitting heat to the compression sub-chambers or for transmitting heat to an external cooling system applicable for heating purposes.

Valves may direct the gas exchange between said chambers within the cyclical arrangement.

The direction of gas exchange between said chambers within the cyclical arrangement may be opposite to the turning direction of the crankshaft.

At least one of the pistons may comprise a cylindrical portion reciprocating along the cylinder axis.

Further, at least one of the pistons may have a wedge shaped portion and may be pivoting about a corresponding pivoting bearing. The pivoting bearing may support said piston from below. Further, the pivoting bearing may be a sliding bearing through which cooling fluid flows.

The mechanical means transmitting force between any of the pistons and the crankshaft may comprise a connection rod. The connection rod connects the pivot of the piston and the crankshaft and transmits force therebetween.

Each pivot may be guided in a slit. The pistons may have internal cooling. In another embodiment, four chambers, each comprising a heated sub-chamber and a cooled sub-chamber, are separated from each other by a separating means such that any change in volume of a heated sub-chamber is similar in magnitude to but of different direction than a corresponding change in volume of the corresponding cooled sub-chamber. The change in volume between the heated sub-chamber and corresponding cooled sub-chamber is caused by a transmittal of mechanical energy between the separating means and any element of a mechanical power buffer system and a crankshaft. The heated sub-chambers are in thermal contact with a heat reservoir and the cooled sub-chambers are in thermal contact with a heat sink. The four chambers are arranged cyclically in order, in either a clockwise or counterclockwise fashion, such that each compression sub-chamber is connected to the subsequent displacing sub-chamber, and each displacing sub-chamber is connected to the subsequent compression sub-chamber via a fluid duct.

The fluid ducts may be the only opening to each heated sub-chamber and each cooled sub-chamber.

The change in volume in each heated sub-chamber or each cooled sub-chamber may only be affected by a movement of said corresponding separating means or by opening or closing said corresponding fluid ducts.

The four chambers may be cyclically arranged around a free internal space comprising said heat reservoir, which is in heat contact with the respective heated sub-chambers of said four chambers.

Four upper heat exchange chambers may be arranged above said free internal space, each being separate of, but in thermal contact with the free internal space, and each being in fluid contact to the respective compression sub-chamber.

Each of the compression sub-chambers may be in fluid contact with a corresponding additional heat transfer chamber provided at portions of the furnace room adjacent to it.

Said free internal space may be constructed in such a manner that substantially all of its surfaces, except areas needed for passage of mechanical parts or fuel supply, delivery air or burning exhaust are used for either transmitting heat to the heated sub-chambers, or for transmitting heat to an external cooling system applicable for heating purposes.

Valves may control the direction of gas exchange between the chambers within the cyclical arrangement.

In either embodiment, the side of the cylinder directed toward the center is usually adapted for heat uptake, which originates from external combustion or from the supply of hot gases. The opposite side serves for cooling by means of cooling fluid. Although this arrangement is usually preferred for practical reasons discussed in detail below, the heating could also be applied at the outside and the cooling at the inside without exceeding the scope of the present invention.

The result of the presented arrangement is a chamber at the respective hot side, which is responsible for air compression and heat uptake, and therefore is responsible for providing force and a chamber at the respective opposite side, which is responsible for cooling and displacing cooled down air.

Each cylinder has several side openings, which are connected to the next cylinder by channels. The channels are arranged so that each heating chamber is connected to the subsequent cooling chamber, and that the cooling chamber is connected to the subsequent chamber to be heated.

The top side of the piston has a pivot, which leads the created force through a slit in the cylinder, and transfers it to the crankshaft by means of a connection rod.

In addition to the exemplary aspects and embodiments described above, further aspects and embodiments will become apparent by reference to the accompanying drawings forming a part of this specification wherein like reference characters designate corresponding parts in the several views.

### BRIEF DESCRIPTION OF THE DRAWINGS

FIG. 1 is a graph showing a numerical simulation of the thermodynamic cycle applied in the present invention.

FIG. 2 is a plan view of a heat engine according to a first embodiment of the invention.

FIG. 3 is a sectional view of the heat engine according to the first embodiment of the invention.

FIG. 4a is a plan view of a heat engine according to a second embodiment of the invention.

FIGS. 4b and 4c are two enlarged sections showing two variants of how to connect a channel to cylinder head corners in the second embodiment.

FIG. 5 is the plan view of a heat engine according to a third embodiment of the invention.

FIG. 6 is a sectional view of the heat engine according to the third embodiment of the invention.

FIG. 7 is a plan view of a fourth embodiment of the invention with varying cross section of channels in combination with optional application of valves.

FIG. 8 is a sectional view of the heat engine according to the fourth embodiment of the invention.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

The invention is directed to a heat engine comprising four chambers, namely a first, a second, a third and a fourth chamber.

Each chamber comprises a compression sub-chamber and a displacing sub-chamber which are separated and sealed from each other by a piston common to both sub-chambers. When the piston movement increases the fluid volume in the compression sub-chamber, the fluid volume decreases in the corresponding displacing sub-chamber and vice versa.

The engine also has a heat reservoir and a heat sink. All compression sub-chambers are in thermal connection with the heat reservoir, and all displacing sub-chambers are in thermal connection with the heat sink.

The four chambers are arranged cyclically, in either a clockwise or counterclockwise direction, wherein the first chamber is followed by the second chamber, the second chamber is followed by the third chamber, the third chamber is followed by the fourth chamber, the fourth chamber is followed by the first chamber. In this cyclical arrangement, each compression sub-chamber is connected to the subsequent displacing sub-chamber via a corresponding fluid duct and each displacing sub-chamber is connected to the subsequent compression sub-chamber via a corresponding fluid duct.

The fluid ducts are opened and closed by the pistons of the chambers they connect and/or on by valves.

The pistons may also control the time of the cycle where the respective chambers are connected or separated from each other. Valves are therefore not necessarily needed, but could be additionally employed in special embodiments to gain more freedom with respect to the dimension of the connecting ducts, as well as the timing of the opening or closing of the connecting ducts between the respective chambers. Valves can control the duct so that the duct will only open if the pressure relationship between the two chambers it connects allows for a flow in the intended direction (clockwise or counterclockwise).

The engine further comprises a crankshaft. Each piston is mechanically connected to the crankshaft by a mechanical means able to transmit force between the piston and the crankshaft.

This arrangement is highly symmetric. The working gas passes through an alternating chain of compression and displacing sub-chambers. Each time it leaves a compression sub-chamber it enters a displacing sub-chamber and vice versa. There are two such chains, interweaved with each other, since each chamber comprises a compression and a displacing sub-chamber, each one being connected in either one of the two chains.

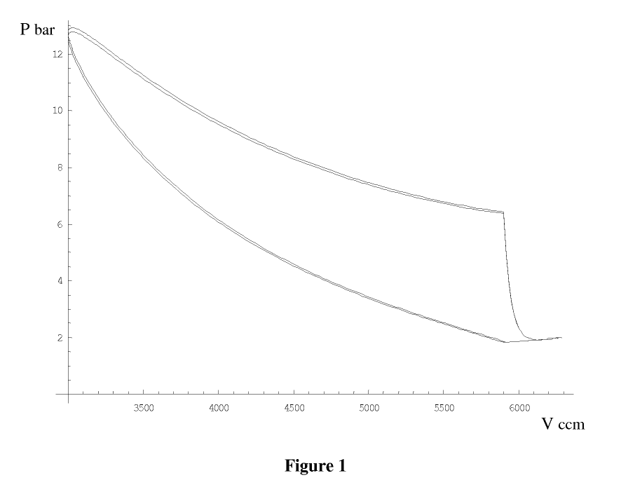

A heat engine according to the present application achieves a special thermodynamic cycle, which is shown in FIG. 1 as a numeric simulation using an exemplary choice of parameters. Those skilled in the art will understand that a range of parameters would be acceptable. In this simulation, the thermodynamic cycle is approximated in a predetermined number of numerical steps to determine the accuracy of the simulation.

A full rotation of the crankshaft is divided into said predetermined number of angular steps, each leading to a corresponding change in volume of all chambers according to the laws of trigonometry and basic geometry, as is well known in the art.

Depending on the relative position of channel openings with respect to the respective pistons, and depending on the size of the channel openings, the channels are either connected with any of two adjacent chambers they are in fluid connection with, or are blocked.

Further, this open/closed state remains valid for a predetermined rotation angle of the crankshaft, being determined by the width of the openings and the crankshaft angle, which together determine the corresponding lateral displacement of the pistons opening or closing edge along the channel opening, again due to trigonometry.

In this manner, the chamber volumes are also connected for some predictable amount of angular displacement. When the chambers are connected, the temperature of their now combined volumes becomes the mixing temperature of the two formerly isolated chamber volumes, and the pressure of their now combined volumes becomes the mixing pressure of the two formerly isolated chamber volumes, which can both be determined by thermodynamics, as is well known in the art.

Within each angular step, a certain change of temperature is assumed on account of the applied heating or cooling, and the resulting temperature and pressure of the respective volume after this step are calculated by isotherms and adiabats.

Therefore, for any rotation angle of the crankshaft, the chamber volumes are determined by geometry, and pressure and temperature of all volumes are determined by the laws of thermodynamics. Thereby, the thermodynamic cycle as a whole is determined by the geometric parameters of the engine and the physical properties of the applied working gas. Therefore, it can be simulated to a sufficient degree of precision.

It should be remarked that the channels add some “dead volume” which is not compressed or expanded, but has to be considered when the volumes of the two adjacent chambers are combined. The dead volume of the channels is usually neither actively cooled nor actively warmed nor isolated, although of course any of these could be possible in further embodiments or refinements hereof.

Further, it would be possible to use the top end of the furnace for additional heat uptake, since additional heated sub-chambers are arranged here, e.g. one for each compression sub-chamber and in fluid contact therewith. These chambers then also add some dead volume to the respective compression sub-chamber(s), but in this case, this dead volume is heated.

The amount of dead volume is of significant influence on the form of the thermodynamic cycle process, i.e. the pressure vs. volume curves, on the gain of mechanical energy created by it as well as the maximum and minimum values of pressure and temperature.

Depending on the parameters of the model, the simulation leads to efficiencies between 10% and 50%. The curve shown in FIG. 1 leads to an efficiency of η=38.8%, which is believed to be reasonable. According to simulation results, the dead value can actually be of a size comparable to or even higher than the volumes of the chambers themselves and still lead to a good efficiency. Heat conduction and heat transfer into the gas and out of the gas should always be arranged to be as efficient as possible.

It should be pointed out that since the readjustment of temperature and pressure after combining two volumes of different temperature and/or pressure takes some time and may depend considerably on the details of the flow situation between the two combined volumes, as e.g. in this case the cross section of channels and the speed of gas exchange, the thermodynamic mixing values of temperature and/or pressure in reality are probably not immediately reached, or maybe even not completely reached during the whole gas exchange period.

In reality, the fluid mixing is somewhere between a complete replacement of the “old” gas of a certain chamber by the “new” gas it receives, without any mixing, and the complete thermodynamic mixing.

It is to be expected, that the assumption of complete thermodynamic mixing leads to a more “rounded” pV-diagram of the thermodynamic cycle having a slightly smaller mechanical efficiency as would be the case in a thermodynamic cycle having a gas exchange without mixture, because the rounded pV-diagram will surround a smaller area within the pV-diagram, thereby creating less mechanical energy per turn of the thermodynamic cycle.

Therefore, it is to be expected that the mechanical efficiency is even higher than the above given simulation results.

In a preferred embodiment, four chambers are in an approximately perpendicular arrangement. This arrangement has several technical benefits due to its high level of symmetry. For example, the order of gas exchange is naturally related to the turning phase of the crankshaft.

If, for example, in this approximately perpendicular arrangement of four chambers, one compression sub-chamber is fully compressed, the next compression sub-chamber of the same gas exchange chain is fully expanded, since it is opposite to the first and has a phase difference of 180 degrees with respect to it, as the gas enters in it only after passing a displacing sub-chamber in between.

The phases of the two displacing sub-chambers are 90 and 270 degrees then, having their piston positions approximately in the middle of their range of mobility, and moving in directions opposite to each other.

The present device could be built with a variable number of chambers, so long as the number of chambers is an integer multiple of four, such as 8 or 12, since this would obey the same rules of the symmetric arrangement, even if the phases with respect to the crankshaft turning position are different.

This arrangement allows for geometric arrangements which optimally exploit the heat generated, e.g. by regenerative fuels, even if their combustion properties are not optimum.

In a preferred embodiment, the furnace room is at the approximate center of the engine, where it is common to all four compression sub-chambers, making the geometric influences on heat distribution more easily optimized. It is also possible to place the heat source to the outside, the cooling to the inside, and switch the roles of compression and displacing sub-chambers. Some minor adjustments of channel cross-section and channel and/or valve positioning might be necessary, but are within the reach of the average person skilled in the art.

It is intended to use as much as possible of the furnace wall areas to transfer heat to the compression sub-chambers. As stated above, besides the four side walls, there is also the top of the furnace room available for heat contact.

Although additional heat transfer could also be established at the bottom, this is less practicable, since the removal of ashes and probably also the supply of fuel will usually be accomplished here, and also because heat has the tendency to rise up, so the possibility to gain additional heat intake is greater at the top.

Another embodiment has four additional chambers on top of the furnace, leaving only the space needed for exhaust fume outtake and possibly a fuel supply. These additional chambers are approximately equal in size. Each of them is connected to a respective adjacent compression sub-chamber which adds to its chamber volume.

This arrangement leads to an additional non-compressible volume portion, so called “dead volume”. On the other hand, these additional chambers give rise to a considerable increase of heat uptake. In addition, as the simulation shows, it may be expected that the additional “dead volume” might not be critical. So it is clear that there will be an optimum chamber volume, where the overall efficiency is optimum.

Another possibility to gain further heat transfer area is to construct similar dead volume zones in those parts of the furnace room's lateral walls that would otherwise remain free between the cylinder heads. If hollow chambers, so called “cylinder head corners” 15 are arranged here as a volume extension of the respective compression sub-chambers, the compression sub-chambers get more dead volume, but also a considerably higher heat transfer area. Of course, any additional heat transfer chamber provided at an area of the furnace room adjacent to, and in fluid contact with, the compression sub-chamber will achieve this benefit. It is not restricted to any particular form.

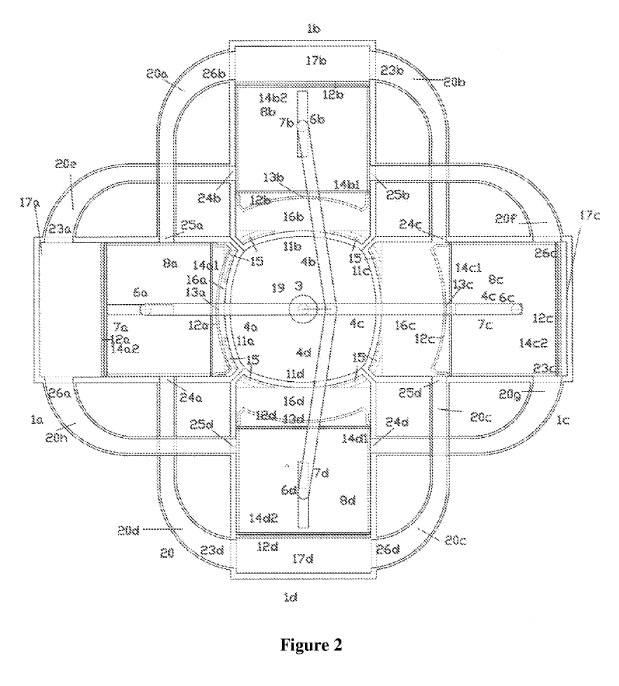

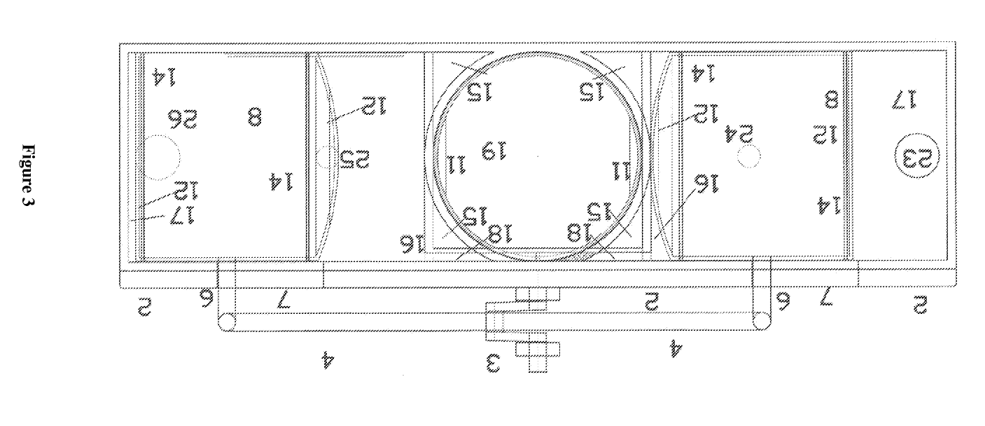

In FIGS. 2 and 3, a first embodiment of the invention is shown, which comprises four cylindrical pistons in a perpendicular arrangement.

These figures show a first piston 8a, a second piston 8b, a third piston 8c and a fourth piston 8d. Each piston is moveable and sealed within a cylinder in such a way that it separates a respective inwardly directed compression sub-chamber 16a to 16d and a respective outwardly directed displacing sub-chamber 17a to 17d.

The compression sub-chambers are arranged inwardly, surrounding the furnace room 19 in the center, with which they are in heat contact through the respective cylinder heads 11a to 11d.

Additional heat conduction structures like rib structures or pipes are not depicted in FIGS. 2 and 3, but may of course be implemented. Due to the geometric arrangement given, the heat transfer area is large even without such additional heat transfer structures.

In top view, the cylinder heads 11a to 11d are round in order to keep the furnace room as round as possible to avoid cooling and soot uptake, which would otherwise probably occur in the corners between the cylinders.

The first compression sub-chamber 16a is connected to the second displacing sub-chamber 17b via a first channel 20a. The second displacing sub-chamber 17b is connected to the third compression sub-chamber 16c via a second channel 20b. The third compression sub-chamber 16c is connected to the fourth displacing sub-chamber 17d via a third channel 20c, and the fourth displacing sub-chamber 17d is connected to the first compression sub-chamber 16a via a fourth channel 20d, whereby the connection of the first cycle of chambers is closed in cyclical manner.

The first displacing sub-chamber 17a is connected to the second compression sub-chamber 16b via a fifth channel 20e. The second compression sub-chamber 16b is connected to the third displacing sub-chamber 17c via a sixth channel 20f. The third displacing sub-chamber 17c is connected to the fourth compression sub-chamber 16d via a seventh channel 20g, and the fourth compression sub-chamber 16d is connected to the first displacing sub-chamber 17a via a eighth channel 20h, whereby the connection of the second cycle of chambers is closed in cyclical manner.

It can be clearly seen that this arrangement is highly symmetrical.

The piston top and the cylinder top region (i.e. furnace side wall of the compression sub-chamber) may of course be of any of several various geometric forms. One preferred option is to form the cylinder top region as round as possible about the furnace room, and to also give the piston top some amount of roundness so that the remaining volume portion when the chamber is fully compressed is as small as possible.

On the other hand, a piston having an approximately perpendicular top would be easier to produce and might still be appropriate, since some amount of non-compressible volume portion might be acceptable.

A further degree of freedom to optimize the timing of gas exchange between the chambers is in chamfering the pistons. A piston chamfered at its upper edge may allow for fluid connection of adjacent chamber ducts, when still too far at the top or bottom side of the respective cylinder to otherwise open the respective duct. The chamfering geometry, e.g. angle, width and depth, are of course further parameters to modify timing and pressure behavior of the gas exchange.

The furnace room does not have to be rounded. For example, the furnace room could have a square cross section. This is easier to produce, and the cylinder and piston arrangement is easier. On the other hand, the corner regions might give rise to dead zones with reduced air exchange, reduced temperature and soot uptake.

According to this first embodiment, an engine comprises the four laying cylinders 1a to 1d, which are arranged perpendicularly around a central furnace room 19. The furnace room 19 is covered by a plate 2, which is also in contact with the laying cylinders 1a to 1d. A crankshaft 3 is centrally located on top of the plate 2 and above the furnace room 19.

In the top face of the furnace room, a cavity 18 is subdivided into four parts 18a to 18d, which are in fluid connection to the respective adjacent cylinder 1a to 1d. The furnace room may be rounded towards those sides, which are adjacent to the cylinders. Its four corners are rounded and are connected with sides in the form of segmental arches. These sides also form the respective cylinder head 11a to 11d of the adjacent cylinder 1a to 1d.

The piston heads 12a to 12d are in approximately the same form as the respective cylinder head 11a to 11d. A piston ring 14a1 to 14d1 is located a short distance from the apex of each piston head 12a to 12d. The diameter may be reduced by chamfering from the apex of each piston head 12a to 12d in the direction of the furnace room (see above).

Cylinder head corners 15a to 15d are formed in each respective cylinder head. Further heat transfer area is obtained by means of the cylinder head corners 15a to 15d, whereby the heat intake is increased. The chamber formed at this side, directed towards the furnace room 19, is called the respective compression sub-chamber 16a to 16d. Therefore, the cylinder head corners 15a to 15d add some additional volume to the respective compression sub-chamber, but also increase its heat uptake.

The chamber formed at the opposite side is the respective displacing sub-chamber 17a to 17d, which is also sealed by respective piston rings 14. The piston rings are placed outside the slits 7a to 7d of the respective pistons, e.g. for piston 8a, piston ring 14a1 seals compression sub-chamber 16a towards the slit region, piston ring 14a2 seals displacing sub-chamber 17a towards the slit region. The other cylinders have the same arrangement.

Piston movement occurs when hot gas is present in the furnace room between the cylinder tops, or when combustion takes place within the furnace room.

The heat in furnace room 19 heats the cylinder heads and the gas within the compression sub-chambers 16a to 16d expands, producing a force onto the respective piston(s) 8a to 8d. At the same time, the gas in the respective displacing sub-chamber 17a to 17d is cooled.

The gas exchange takes place because each of compression sub-chambers 16a to 16d is fluid connected with the respective subsequent displacing sub-chamber 17a to 17d in the perpendicular arrangement of cylinders via cylinder openings 23a to 23d, 24a to 24d, 25a to 25d, 26a to 26d and channels 20a to 20h, as discussed in general above.

The fluid ducts are located at the sides of the cylinders and therefore open with respect to the phase of the crankshaft revolution cycle. Therefore, the size of the openings in the cylinder wall is a critical parameter for determining the length of the respective opening time interval as well as its beginning.

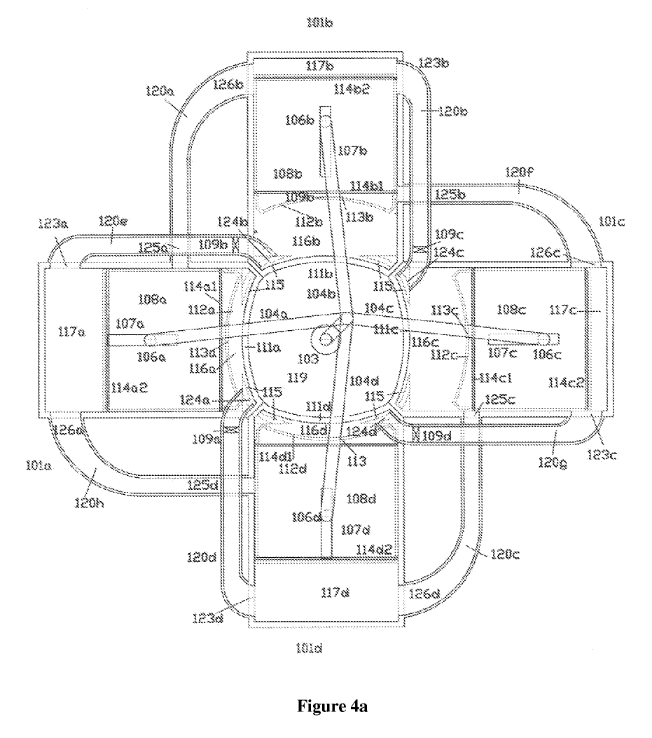

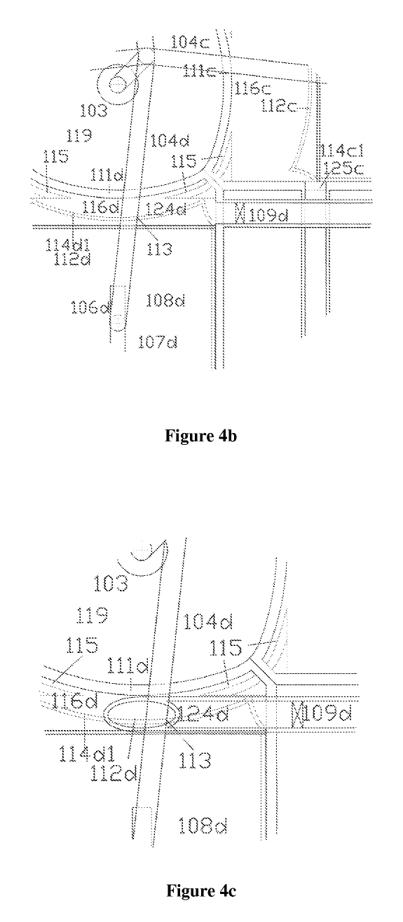

An alternative arrangement of fluid ducts can be seen in FIG. 4a, showing a second embodiment of the invention, which is a modification of the first embodiment. Similar parts are marked by reference signs which are obtained by adding 100 to the reference signs of the corresponding part(s) in the first embodiment.

In this embodiment, fluid ducts are arranged so that their opening and closing occurs very close to the apex of the piston movement. The size and shape of the cylinder opening at which the respective fluid duct starts or ends are such that fluid ducts' projection into the downward direction of the piston is minimal or zero.

Other than in case of the first embodiment, the air supply openings 124a to 124d of the compression sub-chambers open into cylinder head corners 115. The cylinder corners 115 are additional heated areas (“dead volume”) in fluid contact to the respective compression sub-chamber(s). In this case, these channels are not opened and closed by the reciprocation of the piston. Therefore, they are provided with valves 109a to 109d, as e.g. in the form of non-return flaps, to make sure the gas exchange is in the intended direction only.

There are of course several possibilities for arrangement of the fluid ducts. Typical connection areas are in the upper part of the compression sub-chambers, very close to the corners where adjacent cylinders meet, or in the above mentioned cylinder head corners 115, if applicable.

The connection of the fluid ducts to the cylinder head corners can be seen in greater detail in FIGS. 4b and 4c.

As can be seen in these figures, the duct entering the compression sub-chamber after passing a valve 109d (if applicable) may enter the compression sub-chamber either laterally or via a cylinder head corner 115, which is fluid connected to the respective compression sub-chamber, or from upwards or downwards. In all these special cases, and in contrary to the first embodiment, the fluid connection is not controlled by the piston position, but by the valve, if applicable.

Another typical connection area is the outwardly directed wall of the displacing sub-chambers, i.e. their cylinder heads.

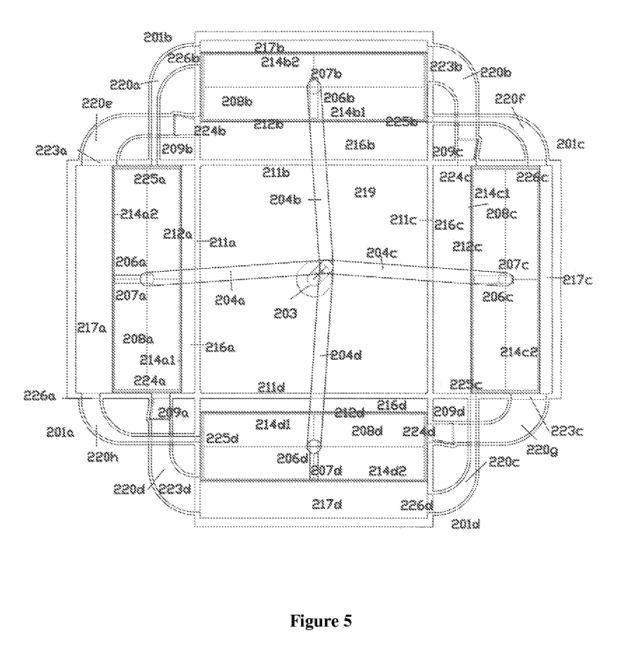

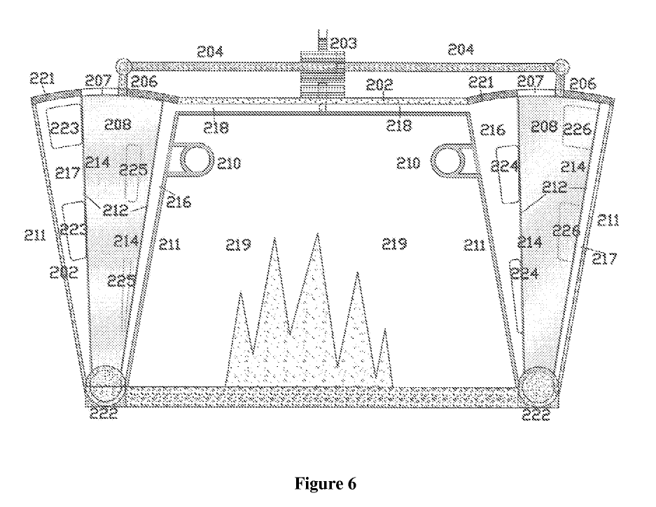

FIGS. 5 and 6 shows a heat engine according to a third embodiment of the invention, comprising four cylinders 201a to 201d of a special geometric form explained in detail below. Cylinders 201a to 201d are connected to the crankshaft 203 by means of a connection rod 204a to 204d with a pivot point 206a to 206d located within a slit 207a to 207d.

The four cylinders 201a to 201d are arranged perpendicularly to each other, wherein cylinder side walls 211 form the front side or back side, respectively, of the cylinder 201a to 201d. In the depicted embodiment, cylinder side walls 211 are in the form of plates.

The lateral ends of cylinders 201a to 201d are formed by circle sectors, in which gas outlet openings 223 are formed at the cold side of the displacing sub-chamber 217, or gas provision openings 226 are formed at the warm side of the displacing sub-chamber 217. Gas outlet openings 225 for the compression sub-chamber 216 and gas provision openings 226 for the displacing sub-chamber 217 are also formed by circle sectors at the lateral ends of cylinders 201a to 201d.

The first compression sub-chamber 216a is connected to the second displacing sub-chamber 217b via a first channel 220a. The second displacing sub-chamber 217b is connected to the third compression sub-chamber 216c via a second channel 220b. The third compression sub-chamber 216c is connected to the fourth displacing sub-chamber 217d via a third channel 220c, and the fourth displacing sub-chamber 217d is connected to the first compression sub-chamber 216a via a fourth channel 220d, thereby closing the cyclical connection of the first cycle of chambers.

The first displacing sub-chamber 217a is connected to the second compression sub-chamber 216b via a fifth channel 220e. The second compression sub-chamber 216b is connected to the third displacing sub-chamber 217c via a sixth channel 220f. The third displacing sub-chamber 217c is connected to the fourth compression sub-chamber 216d via a seventh channel 220g, and the fourth compression sub-chamber 216d is connected with the first displacing sub-chamber 217a via an eighth channel 220h, thereby closing the cyclical connection of the second cycle of chambers.

The individual cylinders 201a to 201d are covered by the upper cylinder ending 221 which has a circular arc shape and has a slit 207 for guiding a pivot 206. Pivot 206 transmits the force from piston to connection rod 204. In the depicted embodiment, cylinder ending 221 is made of steel.

Cylinders 201a to 201d are connected by an isolated plate 202, which also supports crankshaft 203. A region between the individual cylinders forms a triangle for each, and is also isolated as well as closed.

In the cylinders 201a to 201d, pistons 208a to 208d are each mounted in a cone shaped section. Each piston 208a to 208d is supported by the piston bearing 222. Pistons 208a to 208d are all the same or of similar type of construction. In other words, the piston bearing 222 of each piston may comprise a point, onto which and/or by means of which the pistons 201a to 201d are supported.

Piston bearing 222 is preferably provided as a shaft bearing or sliding bearing, enabling the possibility of cooling by means of a bore in piston bearing 222. In this manner, cooling fluid may be led toward the cold side in the direction of the displacing sub-chamber 217, whereby the piston is cooled.

At the upper end of each piston 221, there is a pivot 206 for transmission of force from piston to connection rod 204. The result of this arrangement is that each cylinder 201a to 201d has a chamber for the compression and heating of the air, namely compression sub-chamber(s) 216a to 216d as well as a chamber for cooling and displacing the air, namely displacing sub-chamber(s) 217a to 217d.

To create motion, hot gas is supplied from the internal space 219 to the cylinders 201a to 201d, or combustion takes place in the internal space 219, whereby heat is transferred via cylinder heads 211a to 211d to all compression sub-chambers. Individual cylinders 201a to 201d are connected to one another by channels 220a to 220d, as explained above.

The heating of room 219 heats cylinder walls 211, causing the gas in the compression sub-chamber 216 to expand, which then applies force to the piston.

On the opposite side, the plates as well as the gas in the displacing sub-chamber 217a to 217d are cooled. Channels 220a to 220d connect gas outlet openings 223a to 223d of the cold side with gas provision openings 224a to 224d of the compression sub-chamber 216a to 216d at the warm side of the perpendicularly adjacent next cylinder. This arrangement allows the exchange of gas to take place.

Further, the gas outlet openings 225a to 225d of the compression sub-chamber 216a to 216d of the warm side are connected with the respective gas provision openings 226a to 226d of the displacing sub-chamber 217a to 217d of the cold side, wherein the stream of gas is led in this direction.

In order to secure the exchange of gas in one direction only, the gas outlet openings 223a to 223d of the displacing sub-chamber 217a to 217d and the gas provision openings 226a to 226d of the displacing sub-chamber 217a to 217d are larger than the gas supply opening 224a to 224d of the respective compression sub-chamber 216a to 216d, and the gas outlet openings 225a to 225d of the compression sub-chamber 216a to 216d.

Optionally, additional heat transfer area may be provided by either implementing ribs into the cylinder head plates 211, or by implementing pipe structures 210, which adds some dead volume to the volume of the respective compression sub-chamber, but also improves its heat uptake.

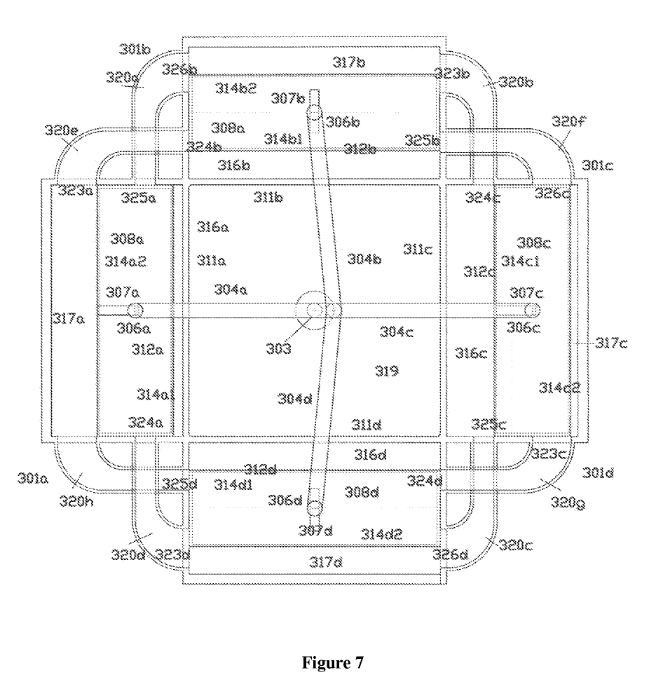

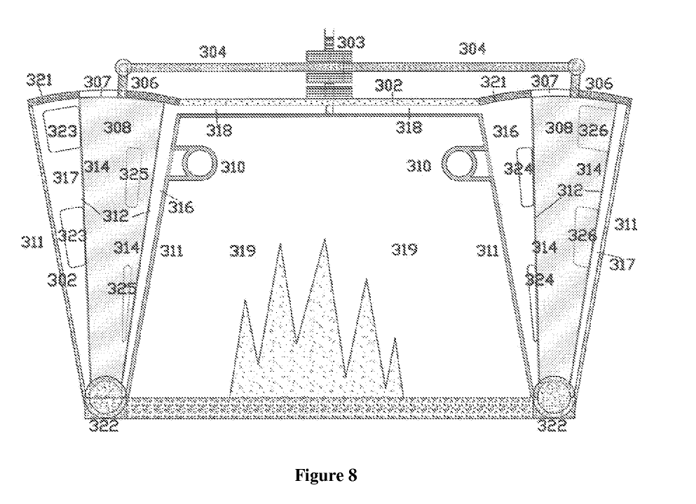

FIGS. 7 and 8 show a fourth embodiment of the invention. The reference numerals of the fourth embodiment are obtained by adding 100 to the reference numerals of the third embodiment, as discussed with reference to FIGS. 5 and 6.

In the fourth embodiment, the air supply openings of the compression sub-chambers are considerably smaller than the air outlet openings. This configuration leads to a longer time interval during which the compression sub-chamber is compressing, and thereby to an increased amount of heat received during this time interval, which leads to higher efficiency.

A valve may be added to the gas outlet openings of the displacing sub-chambers to assist in stabilizing the direction of gas exchange.

This variant could of course also be applied in combination with any other embodiment of the invention. For example, it is possible to reduce the size of the air supply openings of the compression sub-chambers and optionally provide a valve in order to extend the time interval during which the compression sub-chamber is compressing when the pistons and chambers are cylindrical.

While a number of exemplary aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations are within their true spirit and scope. Each apparatus embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. Whenever a range is given in the specification, all intermediate ranges and subranges, as well as all individual values included in the ranges given are intended to be included in the disclosure. When a Markush group or other grouping is used herein, all individual members of the group and all combinations and subcombinations possible of the group are intended to be individually included in the disclosure.

In general the terms and phrases used herein have their art-recognized meaning, which can be found by reference to standard texts, journal references and contexts known to those skilled in the art. The above definitions are provided to clarify their specific use in the context of the invention.

All patents and publications mentioned in the specification are indicative of the levels of skill of those skilled in the art to which the invention pertains. All references cited herein are hereby incorporated by reference to the extent that there is no inconsistency with the disclosure of this specification. Some references provided herein are incorporated by reference herein to provide details concerning additional starting materials, additional methods of synthesis, additional methods of analysis and additional uses of the invention.

Independent of embodiment, the following table shows the individual steps of the cycle for counterclockwise crank rotation and clockwise gas flow and the resulting phases.

| | compression sub-chamber | displacing sub-chamber |
|---|---|---|
| Cyl. | 16, 116, 216, 316 | 17, 117, 217, 317 |

Begin: crank position 12 o'clock

| | | |
|---|---|---|
| 1a, | cooled down gas of the | has pushed cooled down gas |
| 101a | displacing sub-chamber from | completely into compression |
| 201a | cylinder 1d, 101d, 201d, 301d | sub-chamber of cylinder 1b, |
| 301a | is pushing hot gas from the | 101b, 201b, 301b |
| | compression sub-chamber of | |
| | cylinder 1a, 101a, 201a, 301a | |
| | to the displacing sub-chamber of | |
| | the cylinder 1b, 101b, 201b, | |
| | 301b | |
| 1b | closes opening and begins | receives hot gas from |
| 101b | compression while | compression sub-chamber of |
| 201b | simultaneously heating up. | cylinder 1a, 101a, 201a, 301a |
| 301b | | |
| 1c | is completely compressed. | cooling, begins to push hot gas |
| 101c | begins expansion while still | out of cylinder 1d, 101d, 201d, |
| 201c | taking up heat | 301d |
| 301c | | |
| 1d | begins to receive cooled down | pushes cooled down gas into |
| 101d | gas from cylinder 1c, 101c, | cylinder 1a, 101a, 201a, 301a |
| 201d | 201c, 301c | |
| 301d | | |

90 degrees turn: crank position 9 o'clock

| | | |
|---|---|---|
| 1a | closes opening and begins | receives hot gas from |
| 101a | compression while | compression sub-chamber of |
| 201a | simultaneously heating up | cylinder 1d, 101d, 201d, 301d |
| 301a | | |
| 1b | is completely compressed. | cooling, begins to push hot gas |
| 101b | Begins expansion while | out of |
| 201b | simultaneously taking up more | cylinder 1c, 101c, 201c, 301c |
| 301b | heat | |
| 1c | begins to receive cooled down | pushes cooled down gas into |
| 101c | gas out of | cylinder 1d, 101d, 201d, 301d |
| 201c | cylinder 1b, 101b, 201b, 301b | |
| 301c | | |
| 1d | cooled down gas of the | has pushed cooled down gas |
| 101d | displacing sub-chamber of | completely into the |
| 201d | cylinder 1c, 101c, 201c, 301c | compression sub-chamber of |
| 301d | pushes hot gas of the | cylinder 1a, 101a, 201a, 301a |
| | compression sub-chamber of | |
| | cylinder 1d, 101d, 201d, 301d | |
| | to the displacing sub-chamber of | |
| | cylinder 1a, 101a, 201a, 301a | |

90 Grad turn: crank position 6 o'clock

| | | |
|---|---|---|
| 1a | is completely compressed, | cooling, begins to push hot gas |
| 101a | begins expansion while | out of |
| 201a | simultaneously taking up more | cylinder 1b, 101b, 201b, 301b |
| 301a | heat | |
| 1b | begins to receive cooled down | pushes cooled down gas into |
| 101b | gas from | cylinder 1c, 101c, 201c, 301c |
| 201b | cylinder 1a, 101a, 201a, 301a | |
| 301b | | |
| 1c | cooled down gas of the | has pushed cooled down gas |
| 101c | displacing sub-chamber of | completely into the |
| 201c | cylinder 1b, 101b, 201b, 301b | compression sub-chamber of |
| 301c | pushes hot gas of the | cylinder 1d, 101d, 201d, 301d |
| | compression sub-chamber of | |
| | cylinder 1c, 101c, 201c, 301c | |
| | to the displacing sub-chamber of | |
| | cylinder 1d, 101d, 201d, 301d | |
| 1d | closes opening and begins | receives hot gas from |
| 101d | compression while | compression sub-chamber of |
| 201d | simultaneously heating up | cylinder 1c, 101c, 201c, 301c |
| 301d | | |

90 degrees turn: crank position 3 o'clock

| | | |
|---|---|---|
| 1a | begins to receive cooled down | pushes cooled down gas into |
| 101a | gas from | cylinder 1b, 101b, 201b, 301b |
| 201a | cylinder 1d, 101d, 201d, 301d | |
| 301a | | |
| 1b | cooled down gas of the | has pushed cooled down gas |
| 101b | displacing sub-chamber from | completely into the |
| 201b | cylinder 1a, 101a, 201a, 301a | compression sub-chamber of |
| 301b | pushes hot gas of the | cylinder 1c, 101c, 201c, 301c |
| | compression sub-chamber of | |
| | cylinder 1b, 101b, 201b, 301b | |
| | to the displacing sub-chamber of | |
| | cylinder 1c, 101c, 201c, 301c | |
| 1c | closes opening and begins | receives warm air from |
| 101c | compression while | cylinder 1c, 101c, 201c, 301c |
| 201c | simultaneously heating up | |
| 301c | | |
| 1d | is completely compressed. | cooling, begins pushing hot |
| 101d | Begins expansion while | gas out of |
| 201d | simultaneously taking up more | cylinder 1a, 101a, 201a, 301a |
| 301d | heat | |

List of Reference Signs
(add 100 to 300 depending on embodiment, and
add a-d accordingly depending on cylinder)

| | |
|---|---|
| 1 | cylinder |
| 2 | plate |
| 3 | crankshaft |
| 4 | piston rod |
| 6 | pivot |
| 7 | slit |
| 8 | piston |
| 9 | valve |
| 10 | further heat transfer area |
| 11 | cylinder head |
| 12 | piston head |
| 13 | apex of piston head |
| 14 | piston ring |
| 15 | cylinder head corners |
| 16 | compression sub-chamber |
| 17 | displacing sub-chamber |
| 18 | cavity |
| 19 | furnace room |
| 20 | ducts |
| 21 | upper cylinder ending |
| 22 | piston bearing |
| 23 | gas outlet opening displacing sub-chamber (cold side) |
| 24 | gas supply opening compression side (warm side) |
| 25 | gas outlet opening compression side (warm side) |
| 26 | gas supply opening displacing sub-chamber (cold side) |

I claim:

1. A heat engine, comprising:
a crankshaft;
a heat reservoir;
a heat sink; and
four chambers, namely a first, a second, a third and a fourth chamber;
wherein each chamber comprises a compression sub-chamber and a displacing sub-chamber being separated and sealed from each other by a piston common to both chambers and moveable in such a manner that an increase in volume of a compression sub-chamber caused by movement of said piston corresponds to a similar decrease in volume of the corresponding displacing sub-chamber and vice versa;
and wherein all compression sub-chambers are in thermal connection with the heat reservoir, and all displacing sub-chambers are in thermal connection with the heat sink;
and wherein the four chambers are arranged cyclically, in a clockwise or counterclockwise fashion, wherein the first chamber is followed by the second chamber, the second chamber is followed by the third chamber, the third chamber is followed by the fourth chamber, the fourth chamber is followed by the first chamber, the cyclic arrangement being in such a manner that each compression sub-chamber is connected to the subsequent displacing sub-chamber by means of a corresponding fluid duct, and each displacing sub-chamber is connected to the subsequent compression sub-chamber by means of a corresponding fluid duct;
and wherein each piston is mechanically connected to the crankshaft by a mechanical means able to transmit force between said piston and said crankshaft.

2. The heat engine according to claim 1, wherein said fluid ducts are arranged in such a manner that they are open or closed depending on a position of any of the pistons in any of the chambers connected by the fluid ducts.

3. The heat engine according to claim 1, wherein the direction of gas exchange between said chambers within the cyclical arrangement is controlled by valves.

4. The heat engine according to claims claim 1, wherein each compression sub-chamber and each displacing sub-chamber has no openings other than said fluid ducts.

5. The heat engine according to claim 1, wherein the volume in each compression sub-chamber and each displacing sub-chamber only changes by movement of a corresponding piston or by opening or closing the corresponding fluid ducts.

6. The heat engine according to claim 1, wherein the four chambers are arranged cyclically around an open internal space comprising said heat reservoir which is in heat contact with the compression sub-chambers of the four chambers.

7. The heat engine according to claim 6, wherein:
four upper heat exchange chambers, namely a first, a second, a third and a fourth upper heat exchange chamber, are located above the open internal space;
each upper heat exchange chamber is separate from, but in thermal contact with the open internal space; and
each upper heat exchange chamber is in fluid contact with the respective compression sub-chamber.

8. The heat engine according to claim 7, wherein the four upper heat exchange chambers are thermally isolated towards upwards.

9. The heat engine according to claims claim 1, wherein each compression sub-chamber is in fluid contact with an additional heat transfer chamber which is located in the furnace room adjacent to the compression sub-chamber.

10. The heat engine according to claim 1, wherein the open internal space is constructed in such a manner that substantially all of its surfaces, except areas needed for possible passage of fuel supply, air delivery or exhaust of fumes or ashes from burning, are used for either transmitting heat to the compression sub-chambers, or for transmitting heat to an external cooling system applicable for heating purposes.

11. The heat engine according to claim 1, wherein the direction of gas exchange between said chambers within the cyclical arrangement is opposite to the turning direction of the crankshaft.

12. The heat engine according to claim 1, wherein at least one of said pistons comprises a cylindrical portion reciprocating along the cylinder axis.

13. The heat engine according to claim 1, wherein at least one of said pistons has a wedge shaped portion and pivots about a corresponding pivoting bearing.

14. The heat engine according to claim 13, wherein said pivoting bearing supports said piston from below.

15. The heat engine according to claim 14, wherein said pivoting bearing is formed as a sliding bearing through which cooling fluid flows.

16. The heat engine according to claims 13, wherein the mechanical means able to transmit force between any of the pistons and the crankshaft comprises a pivot connected to and transmitting force with said piston and a connection rod connected between said pivot and said crankshaft which transmits force between said pivot and said crankshaft.

17. The heat engine according to claim 16, wherein any of said pivots is mounted in a slit.

18. The heat engine according to any of claims 13, wherein any of said pistons has internal cooling.

19. Method for generating mechanical energy from heat wherein:
four chambers, namely a first, a second, a third and a fourth chamber, each comprising a heated sub-chamber and a cooled sub-chamber, are separated from each other by a separating means in such a manner, that any change in volume of a heated sub-chamber is similar in magnitude to but of different direction than a corresponding change in volume of the corresponding cooled sub-chamber,
said change in volume between said heated sub-chamber and said corresponding cooled sub-chamber belonging to the same chamber being related to a transmittal of mechanical energy between said separating means of said chamber and any of a mechanical power buffer system and a crankshaft,
said heated sub-chambers being in thermal contact with a heat reservoir, said cooled sub-chambers being in thermal contact with a heat sink,
and wherein the four chambers, in a clockwise fashion, wherein the first chamber is followed by the second chamber, the second chamber is followed by the third chamber, the third chamber is followed by the fourth chamber, the fourth chamber is followed by the first chamber, or a counterclockwise fashion, are arranged cyclically, and the cyclic arrangement is in such a manner, that by means of a corresponding fluid duct each compression sub-chamber is connected to the subsequent displacing sub-chamber in this cyclical arrangement, and each displacing sub-chamber is connected to the subsequent compression sub-chamber in this cyclical arrangement.

20. Method according to claim 19 wherein said fluid ducts are arranged in such a manner that they are open or closed depending on a position of any of the pistons in any of the chambers connected by the fluid ducts.

21. Method according to claim 19, wherein the direction of gas exchange between said chambers within the cyclical arrangement is controlled by valves.

22. Method according to claim 19, wherein each heated sub-chamber and each cooled sub-chamber has no openings other than said fluid ducts.

23. Method according to claim 19, wherein the volume in each compression sub-chamber and each displacing sub-chamber only changes by movement of a corresponding piston or by opening or closing the corresponding fluid ducts.

24. Method according to claim 19, wherein the four chambers are cyclically arranged around an open internal space comprising said heat reservoir which is in heat contact with the compression sub-chambers of the four chambers.

25. Method according to claim 19, wherein:
above said open internal space there are provided four upper heat exchange chambers, namely a first, a second, a third and a fourth upper heat exchange chamber;
each upper heat exchange chamber being separate from, but in thermal contact with the free internal space; and
each upper heat exchange chamber is in fluid contact with the respective compression sub-chamber.

26. Method according to claim 19, wherein each compression sub-chamber is in fluid contact with an additional heat transfer chamber which is located in the furnace room adjacent to the compression sub-chamber.

27. Method according to claim 19, wherein the open internal space is constructed in such a manner that substantially all of its surfaces, except areas needed for possible passage of fuel supply, air delivery or exhaust of fumes or ashes from burning, are used for either transmitting heat to the compression sub-chambers, or for transmitting heat to an external cooling system applicable for heating purposes.
